(19) United States
(12) Patent Application Publication
(10) Pub. No.: US 2014/0369214 A1
(43) Pub. Date: Dec. 18, 2014

(54) DEVICE FOR STORING AND RETRIEVING LOGS STORING AND TESTING CIRCUITS

(71) Applicant: UTStarcom Telecom Co., Ltd., Hangzhou (CN)

(72) Inventors: Zhang Jinsong, Hangzhou (CN); Liu Lifeng, Hangzhou (CN); Chen Xiaoyun, Hangzhou (CN)

(73) Assignee: UTStarcom Telecom Co., Ltd., Hangzhou (CN)

(21) Appl. No.: 14/242,317

(22) Filed: Apr. 1, 2014

(30) Foreign Application Priority Data
Jun. 17, 2013 (CN) 201320350655.2

(51) Int. Cl. H04L 12/26

(52) U.S. Cl. CPC H04L 43/50
USPC 370/252

(57) ABSTRACT

Disclosed is a device for storing and retrieving log files and testing circuits that includes a Control and Management Module, a Network Interface Module and a Serial Interface Module. The Network Interface Module connects with an SFP interface of data transport network to supply power and achieve a network connection. The Serial Interface Module connects to a serial port of equipment to store the output logs into the device. Remote management equipment can access the inventive device via telnet or other means. The device can be conveniently carried and installed and can work automatically after power up, which avoids taking additional power from the equipment room and saves on installation space.

### PRIORITY

This application claims priority to Chinese Application No.: 201320350655.2 filed Jun. 17, 2013, the entire contents of which is incorporated herein by reference in its entirety.

### TECHNICAL FIELD

The present invention is related to the field of communications, and more specifically to a device for storing and retrieving log files and testing circuits.

### BACKGROUND

In recent years, the demand for data services is increasing rapidly, whereas the annual growth of narrowband and/or conventional voice services has been little to none. New services such as 3rd Generation (3G) mobile services, Level 2/Level 3 Virtual Private Networks (L2/L3 VPN), and Internet Protocol TeleVision (IPTV) use packet-based data traffic and utilize the bulk of most carrier and service provider bandwidth. As the demand for data services rapidly grows, providers are facing the challenge of how to lower the cost of providing these services. Carriers and service providers are searching for new transport technology that will enable them to deliver services more profitably and efficiently in a highly competitive telecommunications market.

Today, many carriers must operate and maintain multiple networks or different layers of the network. With data traffic consuming the majority of carrier bandwidth in the current Synchronous Digital Hierarchy/Synchronous Optical NETwork (SDH/SONET) infrastructure, it is critical for today's carriers and service providers to use a convergence transport technology. One of the main objectives of the next generation transport network is the ability to multiplex and aggregate multiple services over the same physical facility or infrastructure. This ability enables a provider to provision new services on the existing facility without upgrading the physical installation for every new service. One of the technologies used in modern Packet Transport Network (PTN) technology takes advantage of the cost-effectiveness and ease-of-use of Pseudo Wire (PW) over Transport MultiProtocol Label Switching/MultiProtocol Label Switching Transport Profile (T-MPLS/MPLS-TP) architecture RFC 3985, and adds carrier-class features such as traffic engineering, Quality of Service (QoS) and connection oriented provisioning. The introduction of T-MPLS/MPLS-TP Pseudo Wire (PW) based PTN to metro transport networks permits network operators to migrate all of their transport services to be carried over converged IP/T-MPLS/MPLS-TP core networks. This approach allows carriers and service providers to generate more revenue by rapidly introducing new, as well as existing services, while reducing operational and capital network costs.

At present, the operation logs of existing equipment are stored in two ways. A first method is to store the logs on the Dynamic Random Access Memory (DRAM) within the equipment. Generally though, the equipment has limited memory space and will lose the stored logs after power interruption. Another method is to print and store the logs by using an external Personal Computer (PC) terminal, which needs additional installation space and power supply.

To manage network and data services better, both manufactures and telecommunications (“telecom”) operators are looking to use special external devices to store and maintain more logs for longer periods of time, while requiring the special external devices to have a low power consumption, a large memory and be easy to maintain.

### SUMMARY OF THE INVENTION

The present disclosure relates to resolve the technical problem related to the current testing requirements that are complicated and require a separate connection to the test equipment. The present disclosure relates to an external device for storing log files, retrieving the log files and testing the circuits. The present disclosure provides network connection diagnosis and daily management and maintenance for the equipment.

The device for storing and retrieving log files and testing circuits is installed in a transceiver Small Form-factor Pluggable (SFP) interface of the data transport network product. One end of the device can connect to the SFP interface to be supplied power and connect to the network in order to remotely communicate with the management equipment. Another end of the device uses a Registered Jack (RJ)-45 connector to provide two Recommended Standard (RS) 232 serial interfaces, which connect with serial ports of the equipment. The output logs of the equipment can be stored in the device and remote management equipment can access the device via a TELephone NETwork (telnet), Internet, or other network interconnection scheme.

The device for storing and retrieving log files and testing circuits is designed to remotely store and retrieve logs of the equipment and test the circuits. The device for storing and retrieving log files and testing circuits includes a Control and Management Module used to control the operation of the embedded operating system in the device, so that the module can store the logs from the output serial port of the equipment and establish the file system. The Control and Management Module supports a File Transfer Protocol (FTP) server function, ping function (as a client) and telnet sever function; other functions are contemplated.

The device for storing and retrieving log files and testing circuits further includes a Network Interface Module having one end connected to the Control and Management Module, and another end connected to the transceiver SFP interface of the data transport network to supply power and achieve a network connection.

The device for storing and retrieving log files and testing circuits further includes a Serial Interface Module to connect the Control and Management Module with a serial port of the equipment, and is used for receiving the logs from the output serial port of the equipment.

The Control and Management Module also includes a storage unit, which is used for the real-time storing of the logs from the serial port of the equipment.

The Control and Management Module, Network Interface Module and Serial Interface Module are encapsulated in a transceiver SFP electrical module.

The Control and Management Module includes a micro Central Processing Unit (CPU) or processor to provide overall control for the device. The storage unit of the Control and Management Module includes a built-in memory card. The Control and Management Module includes a Media Access Control (MAC) unit.

The Network Interface Module includes a first PHYsical layer interface device (PHY1) and a second PHYsical layer interface device (PHY2). One end of PHY1 connects the MAC unit through a Reduced Media Independent Interface (RMII) and the other end connects to one end of the PHY2 through a 100 BASE-TX interface. The other end of the PHY2 is a Serial Gigabit Media Independent Interface (SGMII), used to connect with the transceiver SFP interfaces of the data transport network.

The device includes a Power Module, which provides the power supply for the device through the SFP interface of the data transport network.

In addition, the Serial Interface Module connects to a serial port of the equipment by using a cable. The device has a RJ-45 connector for cable connection, which provides two RS232 serial interfaces.

The device for storing and retrieving log files and testing circuits is of similar size with a standard SFP electrical module, which is convenient to carry and install. When installed in the SFP interface of the data transport network product, the device can power up and work automatically, which avoids the need for taking additional power from the equipment room and saves on installation space.

### BRIEF DESCRIPTION OF THE DRAWINGS

The present disclosure will become more readily apparent from the specific description accompanied by the following drawings, in which:

FIG. 1 is a diagram illustrating the structure of the device for storing and retrieving log files and testing circuits;

FIG. 2 is a perspective view of the device for storing and retrieving log files and testing circuits;

FIG. 3 is a block diagram illustrating the device for storing and retrieving log files and testing circuits;

FIG. 4 is a perspective view of the device for storing and retrieving log files and testing circuits connected to equipment and the network; and

FIG. 5 is a block diagram illustrating a connection test of the device for storing and retrieving log files and testing circuits.

### DESCRIPTION OF THE PREFERRED EMBODIMENTS

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

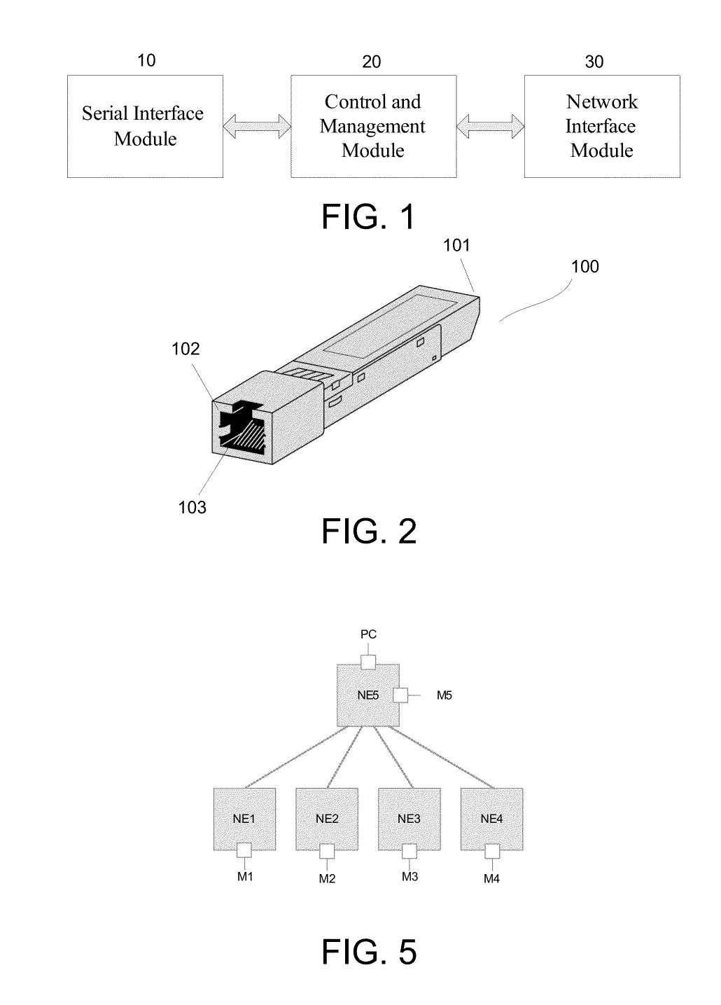

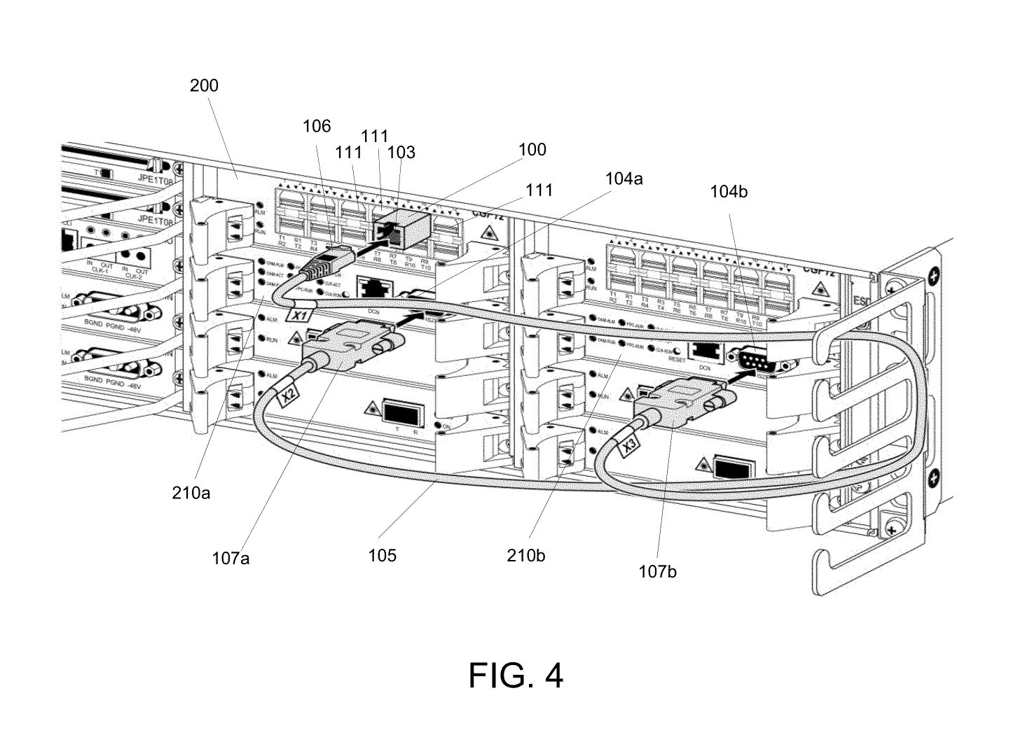

The device for storing and retrieving log files and testing circuits according to the present disclosure is shown in FIGS. 1 and 2. The device for storing and retrieving log files and testing circuits 100 includes a Control and Management Module 20, a Network Interface Module 30 and a Serial Interface Module 10 (e.g. RS232 Interface Module). A first end 101 of the device 100 connects the transceiver SFP interface 111 (see FIG. 4) of the data transport network 200 through Network Interface Module 30. A second end 102 that includes a connector 103, e.g. an RJ-45 connector, of the device 100 connects to one or more output serial ports 104a/104b of the equipment 210a/210b by using a cable 105. The remote management equipment (not shown) can configure and manage device 100 via telnet, or other network connection, and can also remotely retrieve the logs stored in the device 100 through File Transfer Protocol (FTP), or other known file transfer methods.

The Network Interface Module 30 connects the data transport network 200 such that the device 100 can connect with the transceiver SFP interface 111 of the data transport network 200 to provide power and achieve a network connection.

The Serial Interface Module 10 connects with the serial port 104a or 104b of the equipment 210a/210b and is used for receiving the output logs of the equipment 210a/210b.

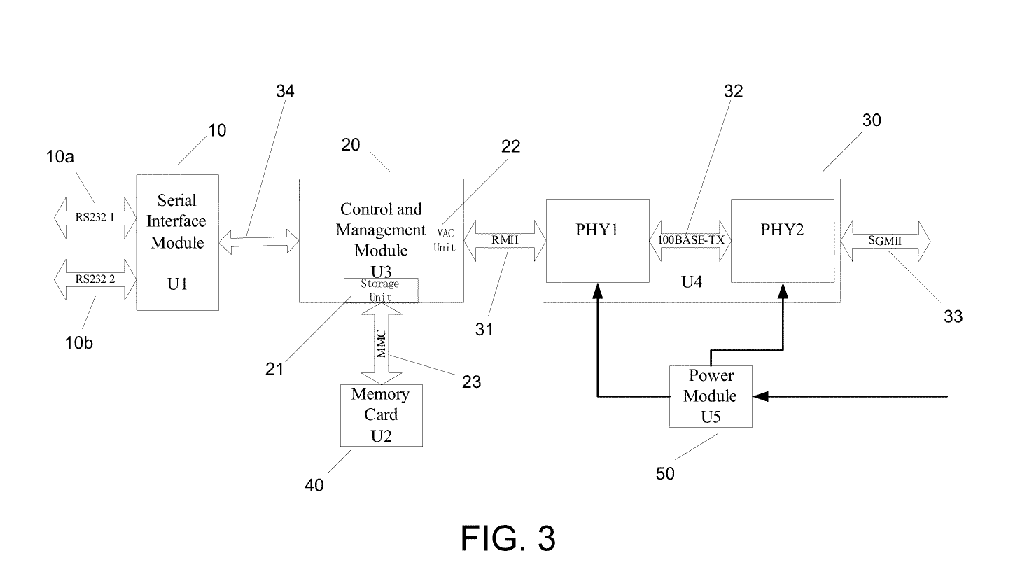

The Control and Management Module 20 includes a storage unit 40 (see FIG. 3), which is used for real-time storing of the logs obtained through the serial port 111 of the equipment 210a/210b. The storage unit 40 can be any type of memory devices, e.g. flash memory.

In a preferred embodiment of the device 100 the Control and Management Module 20, Network Interface Module 30 and Serial Interface Module 10 are shown encapsulated in a transceiver SFP electrical module 100, as illustrated in FIG. 2.

The internal structure of the device 100 is shown in FIG. 3 and includes Serial Interface Module U1 10, Control and Management Module U3 20, Network Interface Module U4 30, Memory Card U2 40, and Power Module U5 50.

In this embodiment, the Serial Interface Module 10 provides two RS232 interfaces: RS232 1 and RS232 2, 10a and 10b, respectively. The Serial Interface Module U1 10 connects the serial port 104 of the equipment 210a/210b by using the cable 105. The first end 101 of the device 100 has an RJ-45 connector 103 to connect with RJ-45 end 106 of cable 105. At the other end of the cable 105 are two RS232 interfaces 107a/107b to connect two serial interfaces 104 of the equipment 210a/210b. The Control and Management Module U3 20 uses a micro Central Processing Unit (CPU) to control data storage from the serial port(s) 104a/104b, file system establishment, Ethernet communication, FTP server function, etc. The Serial Interface Module U1 10 connects to the Control and Command Module U3 20 through connection 34. The Control and Management Module U3 20 includes Media Access Control (MAC) unit 22 and storage unit 21. The memory card U2 40 uses an embedded Multi Media Card (eMMC) card through an MMC connection 23 in this embodiment, which is installed in the storage unit 21 of the Control and Management Module U3 20 to store the logs from the serial port(s) 104a/104b; other configurations are contemplated.

Network Interface Module U4 30 includes a first PHYsical layer interface device (PHY1) and a second PHYsical layer interface device (PHY2). One end of PHY1 connects to MAC unit 22 through a Reduced Media Independent Interface (RMII) 31 and the other end of PHY1 connects to a first end of the PHY2 through a 100 BASE-TX interface 32. The other end of the PHY2 is supplied with a Serial Gigabit Media Independent Interface (SGMII) 33 used to connect with the SFP interfaces 111 of the data transport network 200.

In this embodiment, the device 100 includes the Power Module U5 50. The Power Module U5 50 can convert 3.3 V power supply from SFP interface 111 of the data transport network 200 into 1 V and 2.5 V in order to meet the power supply needs for PHY1 and PHY2 and the other components of device 100.

The Control and Management Module U3 20 can include an internal memory and/or flash memory (not shown). The internal memory provides the device 100 with the required program and data space and the flash is used for storing program and static data.

The peripheral interfaces at the ends 101/102 of the device 100 can be configured to support Ethernet port configuration, serial port configuration and/or eMMC card controller configuration to reduce the number of external devices.

The application embodiment of the device 100 is shown in FIG. 4. The device 100 connects to an SFP interface 111 of the data transport network product 200 through the Network Interface Module 30. The other end of the device 100 connects the serial port 104 of the equipment 210a/210b by using cable 105. The device 100 will automatically record the output data from the serial port 104 and store in the eMMC card, which can be read and downloaded through FTP by the user for testing.

FIG. 5 illustrates and example of the testing process according to an embodiment of the present disclosure. There are five data transport networks NE1, NE2, NE3, NE4 and NE5 that make up the network. NE5 is the center Network Element (NE) and the other NEs are edge NEs. Five devices 100 (M1, M2, M3, M4 and M5) are installed respectively in unused SFP interfaces of the five NEs. By using a special cable, the RJ-45 interface of each device can be connected with serial ports 104a/104b (DB9, X2 and X3) of the equipment 210a/210b.

The devices M1-M5 record the logs from the serial port of the equipment 210a/210b to store in respective eMMC cards automatically. The remote management equipment PC can retrieve the operation logs of the four NEs (NE1, NE2, NE3 and NE4) through the center NE NE5.

The procedures using the device 100 to read the operation logs of the equipment 210a/210b will now be described. If a user needs to download the log files of NE1 and the Internet protocol (IP) address of the device 100 installed in NE1 (i.e. M1) is for example set to 192.168.10.225, the following steps are performed.

In step 1 a local directory is created on the remote PC for NE1 to store corresponding log files: e.g. d:\NE1_log. In step 2 a command window is opened to enter an ftp command: e.g. ftp 192.168.10.225. In step 3, a username and password can be required to be entered to access the device 100: e.g. User <192.168.10.225>/Password: admin. In step 4 a command can be entered to show the folders of the device 100: e.g. ftp>Is. In turn, the folders are displayed (4 in this example): Directory_A_1; Directory_A_2; Directory_B_1; Directory_B_2. In step 5 the required directory is specified as the current directory to retrieve the log files from \Directory_A_1: e.g. ftp>cd Directory_A_1. In step 6, the log file names in \Directory_A_1 can be displayed: e.g. ftp>Is. In turn, all the log files in Directory_A_1 are displayed: e.g. LOG_1.TXT; LOG_2.TXT; LOG_3.TXT; LOG_4.TXT. In step 7 a specific directory can be specified as the local directory: e.g. ftp>Icd d:\NE1_log. In step 8 log files from Directory_A_1 can be downloaded to the directory: d:\NE1_log: e.g. ftp>mget *.TXT.

The procedures using the device 100 to test the circuits of a data transport network 200 will now be described. In this example, it is presumed that the user has configured the circuit from NE5\Slot5\Port3 to NE1\Slot5\Port2. In order to check whether the circuit configuration is successful, the traditional method is to test the configuration by connecting data communication test equipment (e.g. Smart BITS) to each port. In the present disclosure, device 100 is inserted into NE1\Slot5\Port2 to test the configuration. If the IP address of the device 100 is 192.168.10.225, the following steps are performed.

In step 11, on the PC, select [Start>run]. In step 12, enter <cmd> and click <OK>. In step 13, the command window is displayed. In step 14 “ping 192.168.10.225” in entered. In step 15 the Enter key is pressed to check whether the connection is successful. In step 16, the following may be returned:
C:\Users\hz05311>ping 192.168.10.225
Pinging 192.168.10.225 with 32 bytes of data:
Reply from 192.168.10.225: bytes=32 time=1 ms TTL=255
Reply from 192.168.10.225: bytes=32 time=1 ms TTL=255
Reply from 192.168.10.225: bytes=32 time<1 ms TTL=255
Reply from 192.168.10.225: bytes=32 time=8 ms TTL=255
Ping statistics for 192.168.10.225:
   Packets: Sent=4, Received=4, Lost=0 (0% loss),
Approximate round trip times in milliseconds:
Minimum=0 ms, Maximum=8 ms, Average=2 ms.

If the test passes, the service configuration is successful.

Where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A device for the storage and retrieval of logs and circuit testing of a data transport network, comprising:
a control and management module for controlling the device to store and/or retrieve the logs obtained through a serial port of equipment and test circuits of the network;
a network interface module connected to the control and management module, and configured to connect to a Small Form-factor Pluggable (SFP) interface of the data transport network to obtain power and a network connection; and
a serial interface module connected to the control and management module and configured to connect to a serial port of the equipment to obtain the logs from the equipment.

2. The device as claimed in claim 1, wherein the control and management module includes a storage unit for storage of the logs obtained through the serial port of the equipment.

3. The device as claimed in claim 1, wherein control and management module, network interface module and serial interface module are encapsulated in a transceiver SFP electrical module having a first end configured to connect with the SFP interface of the network, and second end configured to connect with the serial port of the equipment.

4. The device as claimed in claim 3, wherein the control and management module includes a micro Central Processor Unit (CPU).

5. The device as claimed in claim 4, wherein the storage unit of the control and management module includes a built-in memory card.

6. The device as claimed in claim 3, wherein the control and management module includes a Media Access Control (MAC) unit.

7. The device as claimed in claim 6, wherein the network interface module includes a first Physical Layer Interface Device (PHY1) and a second Physical Layer Interface Device (PHY2), wherein a first end of the PHY1 is connected to the MAC unit through a Reduced Media Independent Interface (RMII), a second end of the PHY1 is connected to a first end of the PHY2 through a 100 BASE-TX interface, and a second end of the PHY2 is a Serial Gigabit Media Independent Interface (SGMII) configured to connect to the transceiver SFP interfaces of the network.

8. The device as claimed in claim 7, wherein the device includes a power module to provide power to the device through the SFP interface of the network.

9. The device as claimed in claim 1, wherein the serial interface module connects to the serial port of the equipment via a cable through an RJ-45 connector configured to provide two RS232 serial interfaces.

10. A Small Form-factor Pluggable (SFP) interface device, comprising:
a first end configured to connect to a SFP interface of a network to obtain power and network access when connected to the network;
a second end configured to connect to a data output port of at least one electronic equipment and read data from the equipment when connected to the equipment;
a network interface module connected to the first end;
a serial interface module connected to the second end;
a memory; and
a processor connected to the network interface module, the serial interface module, and the memory, the processor effective to:
control network connections to the device through the network;
retrieve data from the equipment; and
store the data in the memory.

11. The device of claim 10, wherein the processor is further effective to transmit the data from the device through the network.

12. The device of claim 10, wherein the processor is further configured to run diagnostic tests on the network.
